(19) United States
(12) Patent Application Publication
(10) Pub. No.: US 2022/0039308 A1
(43) Pub. Date: Feb. 10, 2022

(54) Weed and Invasive Plant Removal Tool

(71) Applicant: Fikre Menbere, Elkhart, IN (US)

(72) Inventor: Fikre Menbere, Elkhart, IN (US)

(21) Appl. No.: 17/397,971

(22) Filed: Aug. 9, 2021

Related U.S. Application Data
(60) Provisional application No. 63/062,901, filed on Aug. 7, 2020.

(51) Int. Cl. A01B 1/18; B25G 1/04

(52) U.S. Cl. CPC A01B 1/18; B25G 1/04

(57) ABSTRACT

A weeding device that allows a user to remove weeds, invasive plants, and other small items imbedded in dirt while in a standing position. The weeding device allows for the separation of penetrating and grasping forces so a user may remove fragile weeds from hard ground, tough weeds from soft ground, or any combination thereof with minimal disturbance and damage to the surrounding soil.

### CROSS REFERENCE TO RELATED APPLICATIONS

The present application claims priority under 35 U.S.C. § 119(e) from U.S. Provisional Application Ser. No. 63/062,901, filed Aug. 7, 2020, entitled “Device for Grasping and Removing Weeds or Other Small Plants;” the disclosure of which is hereby incorporated by reference herein in its entirety.

### FIELD OF THE INVENTION

The present invention relates generally to the field of lawn and garden tools and implements. More specifically, the invention is in the subfield of weed removal tools and implements.

### BACKGROUND OF THE INVENTION

Weeds and other invasive plants can be an unsightly and difficult problem to address in lawns, flower beds, fields, and other outdoor areas around homes, businesses, or other properties. Weeds may grow and multiply quickly and require frequent maintenance to remove or kill. Oftentimes weed removal requires the use of chemicals that may be hazardous to the user or that will also kill beneficial or desirable plants. Physical removal of weeds avoids the use of hazardous chemicals but is very labor intensive and often requires a worker or homeowner to spend extended periods of time in a crouched, bent over, or kneeling position.

### SUMMARY OF THE INVENTION

An aspect of an embodiment of the present invention provides a weeding device for physical removal of weeds by the root without the need to crouch, bend over, or kneel. The weeder may allow a worker to quickly and effectively remove a weed, including the main root, without undue strain. Such a device may be particularly useful in areas where hazardous chemicals may not be used because of the risk of exposure to children, pets, or users, or where the desirable plants may be harmed or affected by herbicides.

### DESCRIPTION OF THE DRAWINGS

The accompanying drawings, which are incorporated into and form a part of the instant specification, illustrate several aspects and embodiments of the present invention and, together with the description herein, serve to explain the principles of the invention. The drawings are provided only for the purpose of illustrating select embodiments of the invention and are not to be construed as limiting the invention.

FIG. 1 provides a schematic illustration of an embodiment of a weed removal device.

FIG. 2 provides a schematic illustration of an embodiment of weed removal device with an ejection mechanism.

FIGS. 3 and 4 provide schematic illustrations of the jaws of an embodiment of a weed removal device.

FIG. 5 provides a schematic illustration of the jaws of an embodiment of a weed removal device with a protective sheath.

FIG. 6 provides a schematic illustration of the handle of an embodiment of a weed removal device.

FIGS. 7 and 8 provide schematic illustrations of an adjustment mechanism of an embodiment of a weed removal device.

FIG. 9 provides a perspective illustration of a cross handle of an embodiment of a weed removal device.

FIG. 10 provides a perspective illustration of an embodiment of a weed removal device with a cross handle.

FIGS. 11-13 provide schematic illustrations of an embodiment of weed removal device with a cross handle.

### DETAILED DESCRIPTION OF EXEMPLARY EMBODIMENTS OF THE INVENTION

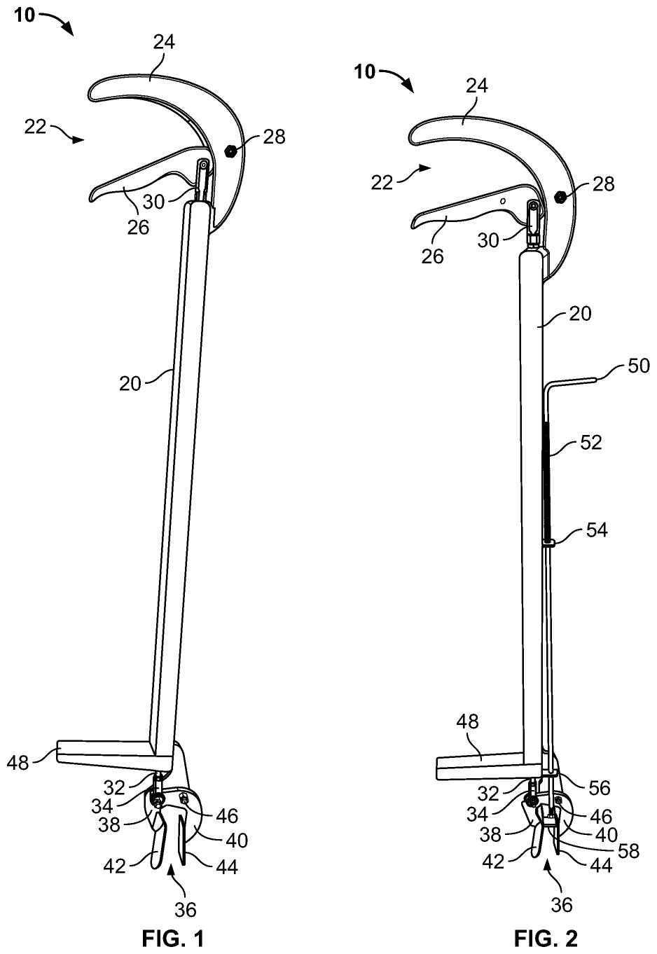

FIGS. 1 and 2 provide depictions of a weeding device 10 for grasping and removing weeds or other small plants from a lawn, flower bed, or other grounds. The device may have a body 20 with a handle 22 at its upper end, a pair of jaws 36 at its lower end, and a pedal 48 located near the jaws 36. The handle 22 may further comprise an upper handle 24 and a lower handle 26, the lower handle 26 being rotatably affixed to the upper handle 24 or the body 20 of the weeding device 10 at a handle pivot 28. The lower handle 26 may be in communication with a rod 32, strut, or other structure via an upper connection 30. It should be appreciated that the rod 32 may be contained within the body 20 of the weeding device 10, or it may be located outside the body 20 of the weeding device 10. The jaws 36 of the weeding device 10 may comprise a fixed jaw 38 having a fixed blade 42 and a moveable jaw 40 with a moveable blade 44, or other similar device for piercing the ground and grabbing or securing a weed, rock, or other item embedded in the ground. The moveable jaw 40 may be rotatably attached to the fixed jaw 38 or the body 20 of the weeding device 10 at a jaw pivot 46 and may be in communication with the rod 32, or a strut or other structure, through a lower connection 34. The body 20 of the weeding device 10 may be tubular or otherwise hollow to allow the rod 32 to pass through the body 20 from the upper connection 30 at the lower handle 26 to the lower connection 34 at the moveable jaw 40, linking the two ends of the weeding device 10. In certain embodiments, the weeding device 10 may include a spring or other return mechanism to bias the jaws 36 in an open position. For instance, a spring may be located on the jaws 36, the rod 32, or the handle 22 to open the jaws 36 or handle 22 after a user has squeezed the handle 22 to close the jaws 36 and prepare the weeding device 10 for the next weed removal.

The lower handle 26 may rotate about the handle pivot 28, and in doing so, through its connection to the rod 32 via the upper connection 30, translate the rod 32 vertically. The motion of the rod 32 is transferred through the lower connection 34 to the moveable jaw 40. As the rod 32 translates vertically, the moveable jaw 40 rotates about the jaw pivot 46. When the lower handle 26 is squeezed or moved upward towards the upper handle 24 (i.e., closing the handle), the rod 32 moves upward and pulls on the moveable jaw 40, which rotates clockwise about the jaw pivot 46 to close the jaws 36 in a grasping or clasping motion. In certain embodiments, the motion of the handle 22 may be translated to the jaws 36 of the weeding device 10 through one or more cables in place of or in addition to the rod 32.

Referring to FIG. 2, the weeding device 10 may also include an ejector 58 for dislodging or displacing a weed or dirt plug that has been removed from the ground and is stuck between the jaws 36 of the weeding device 10. An ejector rod 50 may run through an upper guide ear 54 and a lower guide ear 56 positioned along the outside of the body 20 and terminate in an ejector 58 positioned between the fixed jaw 38 and moveable jaw 40. A spring 52 may hold the ejector rod 50, and consequently the ejector 58, in a retracted position near the jaw pivot 46. The ejector rod 50 itself may be used as a handle through a simple bend at the upper end of the ejector rod 50 for a user to grasp and manipulate. However, in certain embodiments, the ejector rod 50 may be actuated by a foot pedal near the jaws 36 of the weeding device 10, or by a plunger or pad near the handle 22 of the weeding device 10 for a user to strike with his or her palm or hand.

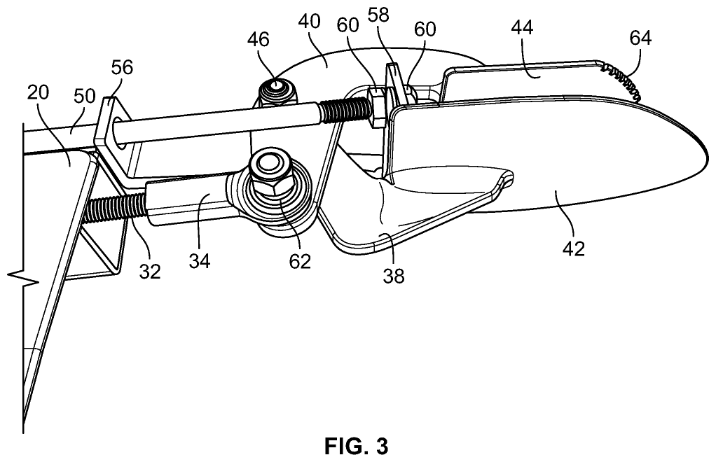

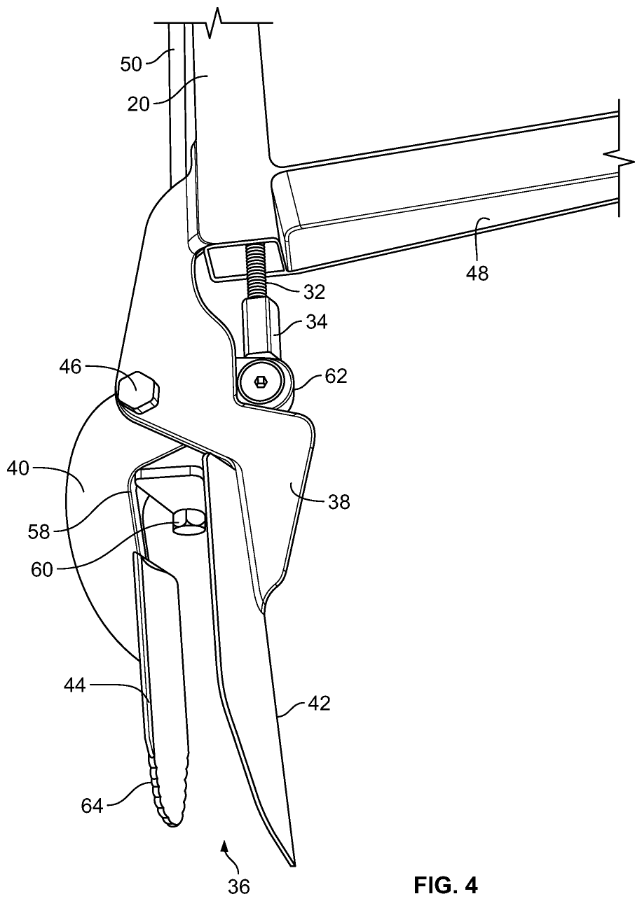

FIGS. 3 and 4 provide depictions of the jaws 36 and lower end of the weeding device 10 of FIGS. 1 and 2. The lower end of the body 20 of the weeding device may include a pedal 48 for applying pressure to the weeding device with a foot, and a fixed jaw 38 solidly mounted to the body 20 of the weeding device. A moveable jaw 40 is rotatably affixed to the fixed jaw 38 at a jaw pivot 46 that allows the moveable jaw 40 to rotate relative to the fixed jaw 38. The moveable jaw 40 is also in communication with a rod 32 extending from the body 20 of the weeding device through a lower connection 34. The translational motion of the rod 32 is transferred to the moveable jaw 40 through the lower connection 34. As the rod 32 translates upwards, it causes the moveable jaw 40 to pivot about the jaw pivot 46 and close the jaws 36 of the weeding device. In certain embodiments, the lower connection 34 may include a rotating joint 62, such as a rod end bearing or rose joint. The rotating joint 62 allows the rod 32 to translate up and down to pivot the moveable jaw 40 such that the jaws 36 open and close while tolerating small misalignments without binding or restricting the motion of the jaw mechanism. The jaw mechanism may also include an ejector 58 at the end of an ejector rod 50 confined within a lower guide ear 56. The ejector 58 may be affixed or otherwise attached to the ejector rod 50 through one or more bolts 60, or through a threaded connection, or other mechanism that allows for the adjustment of the ejector 50 within the jaws 36 of the weeding device. For example, the ejector 50 may be moved up or down relative to the jaws 36 to position the ejector 50 appropriately to eject weeds and dirt plugs of varying sizes.

Still referring to FIGS. 3 and 4, the jaws 36 of the weeding device may include a fixed blade 42 in communication with the fixed jaw 38 and a moveable blade 44, which may include serrations 64, in communication with the moveable jaw 40 for piercing the ground and grasping a weed, rock, or other item that a user wishes to remove from the ground. The fixed blade 42 and moveable blade 44 may take on any geometry as desired or required and may be pointed, curved, or otherwise shaped to penetrate the ground with a smooth or serrated edge. The fixed blade 42 and moveable blade 44 may also be asymmetric. For example, the fixed blade 42 may be longer to provide the initial penetration to break up the ground when removing a weed without applying excessive force to the moveable blade 44, moveable jaw 40, rod 32, and lower connection 34 mechanisms. In certain embodiments, one of the blades 42, 44 may also be angled towards the other blade 42, 44 to provide enhanced gripping of a weed, rock, or other item to be removed from the ground.

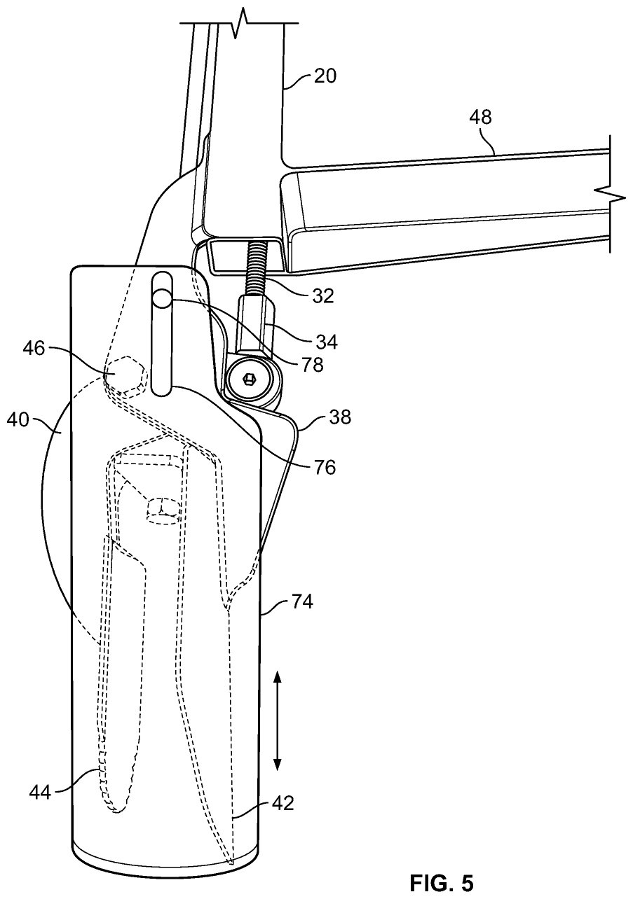

FIG. 5 provides a depiction of the jaws 38, 40 of a weeding device with a protective sheath 74 to cover the blades 42, 44 when the weeding device is not in use. As described above, the weeding device may include a fixed jaw 38 with a fixed blade 42 and a moveable jaw 40 with a moveable blade 44 in communication with the lower end of a body 20 that includes a pedal 48. The moveable jaw 40 may be in communication with a rod 32 through a lower connection 34 that activates the moveable jaw 40 and allows it to rotate about a jaw pivot 46. The rotation of the moveable jaw 40 about the jaw pivot 46 may displace the moveable jaw 40 relative to the fixed jaw 38 to open or close the jaws 38, 40 in a grasping motion. The jaws 38, 40 and jaw mechanism may be covered by a sheath 74 that includes a guide pin 78 disposed within a guide slot 76. The sheath 74 may be in slidable communication with the weeding device wherein the guide pin 78 guides the motion of the sheath 74 as it translates vertically to a retracted position to expose the jaws 38, 40 and their associated blades 42, 44. It should be appreciated that the sheath 74 may be in communication with the weeding device through the body 20 or any part of the jaw mechanism. Furthermore, in certain embodiments the sheath 74 may be held in an extended position covering the jaw mechanism of the weeding device by gravity, a spring, or any other suitable mechanism. The sheath 74 may also be contoured or include multiple slots such that parts of the jaws 38, 40, body 20, pedal 48, or other parts of the weeding device may extend beyond the sheath 74 and not impede its movement from an extended to a retracted position. For instance, the sheath 74 may have one or more slots to allow parts of the fixed jaw 38 or moveable jaw 40 to extend outside the boundary of the sheath 74. The jaws 38, 40 may then guide the sheath 74 through its vertical motion without the need for a guide pin 78 or guide slot 76.

When the weeding device is not in use, the sheath 74 may rest in an extended position and covers or substantially covers the jaws 38, 40 and the blades 42, 44 affixed to the jaws 38, 40 to protect a user or other persons from potential injury from sharp edges or any potential pinch points of the jaw mechanism. During use, a user may position the weeding device in preparation for penetrating the ground and removing a weed, rock, or other item. The user may then force the weeding device against the ground either by applying pressure to the handle or stepping on the pedal 48. As the weeding device is pressed against the ground, the sheath 74 will be braced against the ground and retract as the blades 42, 44 penetrate into the ground and it will translate vertically to allow the blades 42, 44 to extend. The motion of the sheath 74 may be guided or constrained by a guide pin 78 riding in a guide slot 76. When the user pulls the weeding device from the ground, the sheath 74 may return to its extended position by gravity, a spring, or any other suitable return mechanism and once again cover the blades 42, 44 or other parts of the jaw mechanism.

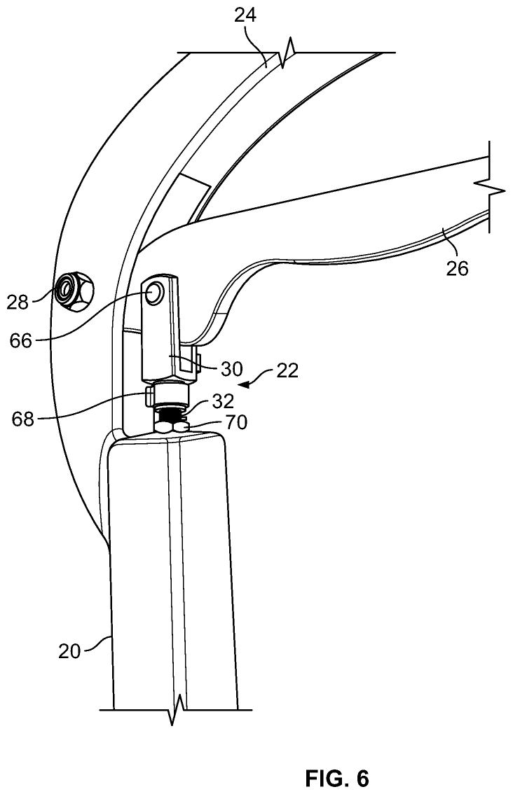

FIG. 6 provides a depiction of the handle 22 and handle pivot 28 of the weeding device. The handle 22 may comprise an upper handle 24 and a lower handle 26 in rotatable communication with the upper handle 24 through a handle pivot 28. The lower handle 26 is in communication with a rod 32 passing through the body 20 of the weeding device through a rotating pivot 66 with an upper connection 30. The upper connection 30 may include an adjustment collar 68 to lengthen or shorten the effective length of the rod 32 and adjust the opening of the weeding device jaws. A lock nut 70 may be used to secure the adjustment collar 68 into a user specified position.

The handle 22 allows a user to squeeze or otherwise move the lower handle 26 closer to the upper handle 24 to activate the rod 32, which directs motion from the handle 22 to the jaws of the weeding device. When the user squeezes the handle 22 or moves the lower handle 26 closer to the upper handle 24, the lower handle 26 pivots about the handle pivot 28 and the upper connection 30 and rod 32 translate vertically along the central axis of the body 20. This motion is then transferred through the rod 32 to the jaws of the weeding device 10 to close the jaws 36 and grasp a weed, rock, or other item embedded in the ground. It should be appreciated that the handle 22 may include ergonomic grips, rubber, foam, or other cushioning materials, or take any geometry, shape, or size as necessary for user comfort. Furthermore, the handle pivot 28 may include one or more locking mechanisms to lock the lower handle 26 in a retracted position. For example, the handle pivot 28 may include a ratcheting mechanism such that when a user squeezes the lower handle 26 towards the upper handle 24, the ratcheting mechanism holds the lower handle 26 in the squeezed position, which also holds the jaws in a closed position grasping a weed, rock, or other item to be removed from the ground. By locking the lower handle 26, and subsequently the jaws, in a closed position, a user may then secure the weed, rock, or other item and then twist, rock, or otherwise manipulate the weeding device without the need to maintain a grip on the lower handle 26 to preserve grasping pressure at the jaws. In such an embodiment, the weeding device may also include a trigger or other release mechanism to release the ratcheting mechanism and release the weed. This trigger may be located on the handle 22, body 20, ejection rod, or any other part of the weeder as desired or required. Similarly, a ratcheting mechanism may allow for progressive application of grasping pressure through repeated squeezing of the lower handle 26. For example, the ratcheting mechanism may allow the lower handle 26 to return to an open or un-squeezed position while locking the rod 32, and subsequently the jaws, in place. This type of mechanism would allow a user to repeatedly squeeze the handle 22 while progressively closing the jaws or applying greater pressure at the jaws which are retained in their position by the ratcheting mechanism. A user may then twist, rock, or otherwise manipulate the weeding device to loosen the weed, rock, or other item without having to hold or maintain grip pressure on the handle. When the weed, rock, or other item has been removed, the user may then use a trigger or other release mechanism to release the ratcheting mechanism and allow the jaws to release the weed, rock, or other item from its grasp.

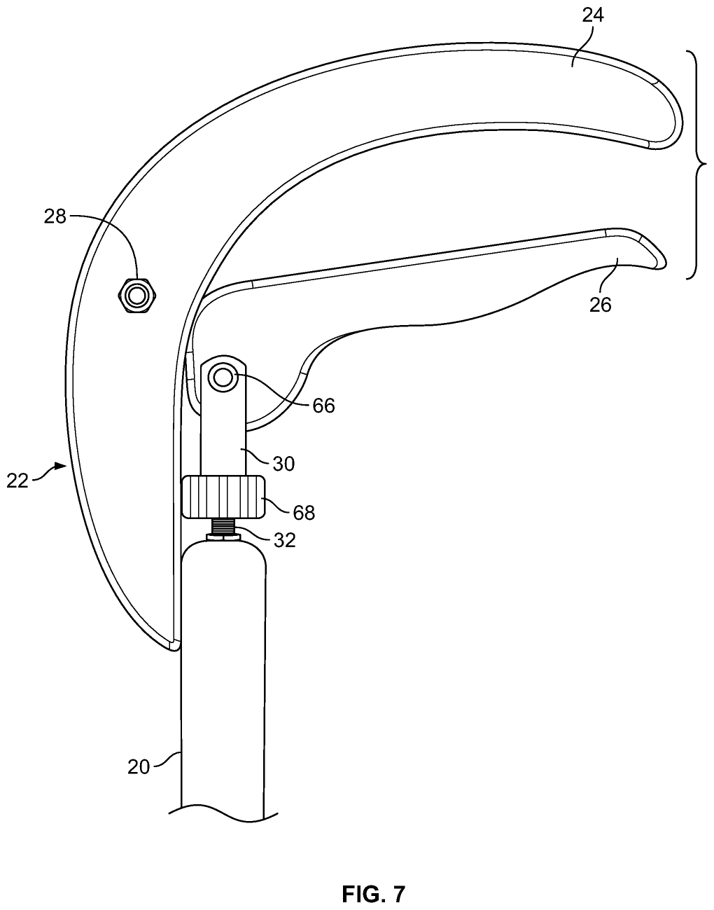

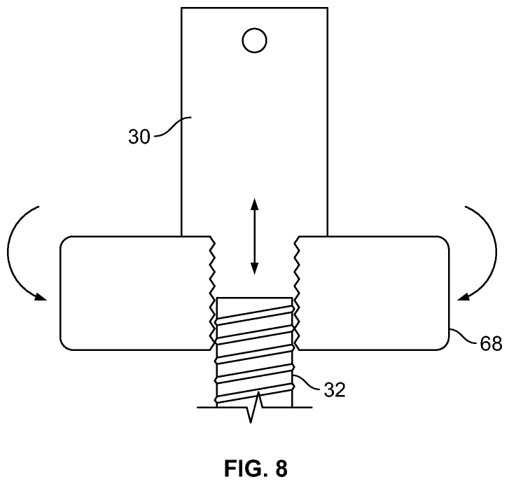

FIGS. 7 and 8 provide schematic depictions of a handle 22 of a weeding device with an adjustment collar 68 to adjust the static opening of the weeder jaws (not shown). The weeder may include a handle 22 at the top of the body 20 comprising an upper handle 24 and a lower handle 26. The lower handle 26 may be rotatably affixed to the upper handle 24 through a handle pivot 28 such that the lower handle 26 may move relative to the upper handle 24. The lower handle 26 may be in communication with a rod 32 passing through the body 20 of the weeder through an upper connection 30 and the adjustment collar 68. When the lower handle 26 is rotated or moved upwards towards the upper handle 24, the rod 32, through the adjustment collar 68 and upper connection 30, also translates upwards and activates the moveable jaw at the lower end of the weeder to close the jaws. A rotating pivot 66 allows the lower handle 26 to rotate about the handle pivot 28 while the upper connection 30 rotates about the rotating pivot 66 to prevent binding of the handle 22 and rod 32 mechanism. The rotating pivot 66 allows for another degree of freedom in the handle 22 and rod 32 mechanisms to help provide translational motion to the rod 32 without excessive twisting or side loading.

The adjustment collar 68 may be rotatably attached to the upper connection 30 such that it may freely rotate about the upper connection 30. In certain embodiments, the adjustment collar 68 may include printed numbers, or may be indexed or include detents to provide the user with set adjustment points or locations for the adjustment of the jaw opening. The adjustment collar 68 may also include internal threads at the mating point with the rod 32, which may also have complimentary threads. The adjustment collar 68 may allow a user to twist the adjustment collar 68, which freely rotates about the upper connection 30, to thread the rod 32 up or down relative to the upper connection 30 and the lower handle 26. The adjustment collar 68 allows the effective length of the rod 32 to be adjusted, subsequently moving the moveable jaw closer or further from the fixed jaw at the lower end of the weeder. The jaw opening may then be adjusted to be larger or smaller for weeds, rocks, or other items of varying size while maintaining a consistent grip distance between the upper handle 24 and lower handle 26 of the weeding device. It should be appreciated that the adjustment of the effective length of the rod 32 may be located at either the handle 22 or jaw end of the weeding device, and any suitable adjustment mechanism may be used including, but not limited to, threaded adjusters, levers, slip joints, cam lock adjusters, or any other available adjustment mechanism.

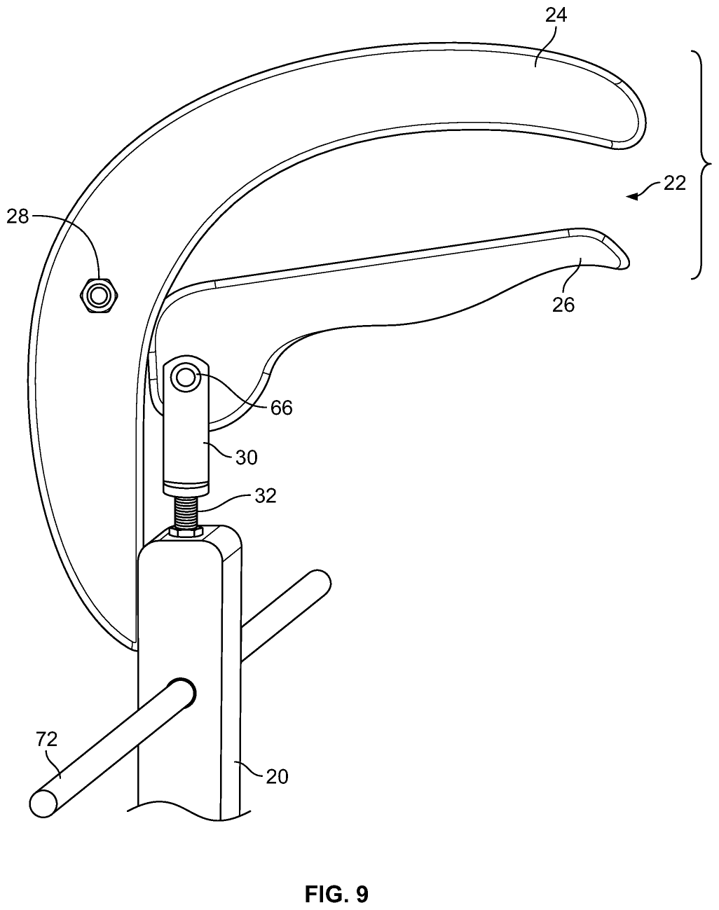

FIG. 9 provides a depiction of a weeding device handle 22 with a cross-grip or T-grip handle 72. As described above, the weeding device may have a hollow body 20 that supports a handle 22 comprising an upper handle 24 and a lower handle 26. The lower handle 26 is rotatably affixed to the upper handle 24 and may rotate about a handle pivot 28. A rod 32 is in communication with the lower handle 26 via an upper connection 30 and a rotating pivot 66 such that when the lower handle 26 is squeezed or otherwise moved upwards, the rod 32 will also translate upwards.

The cross-grip 72 may be in communication with the body 20 or the handle 22 of the weeding device. As shown, the cross-grip 72 may be an additional grip that is mounted perpendicularly to the body 20 of the weeding device and may pass through the body 20 of the weeding device to allow for right- or left-handed use. However, it should be appreciated that the cross-grip 72 may be located at any location as necessary on the weeding device, and it may be positioned in line with, or perpendicular to, the main handle 22. Furthermore, the cross grip 72 may be a simple bar that passes through an opening in the body 20 or a mounting ear attached to the body 20. In certain embodiments, the cross grip 72 may be removable or adjustable by a user. For example, the cross grip 72 may be a shorter bar with a fitting or threaded end that allows it to mate with a complementary fitting or threaded orifice on the body 20 or handle 22 of the weeding device. A user may then move the cross-grip 72 to different locations as necessary for different applications, handedness, or user comfort. The cross-grip 72 may be a simple bar, an ergonomic handle with a rubberized or cushioned grip, or may be mounted to the weeding device at an angle. In certain embodiments the cross-grip 72 may be hinged to allow it to fold into a stowed position next to the body 20 of the weeding device for easier storage, hanging, or to prevent obstruction while the weeding device is in use.

The cross-grip 72 provides an additional location for a user to place their hands while using the weeding device. For instance, when the user applies force on the weeding device to insert the blades into the ground, the cross-grip 72 allows for a second hand placement to apply additional force and for a user to steady himself or herself. In the case of a user applying force through a pedal, the cross-grip 72 again offers the user an additional location to grasp the weeding device for improved stability and control. The cross-grip 72 may also be used to twist the weeding device to loosen or otherwise dislodge a weed, rock, or other item that is to be removed from soil.

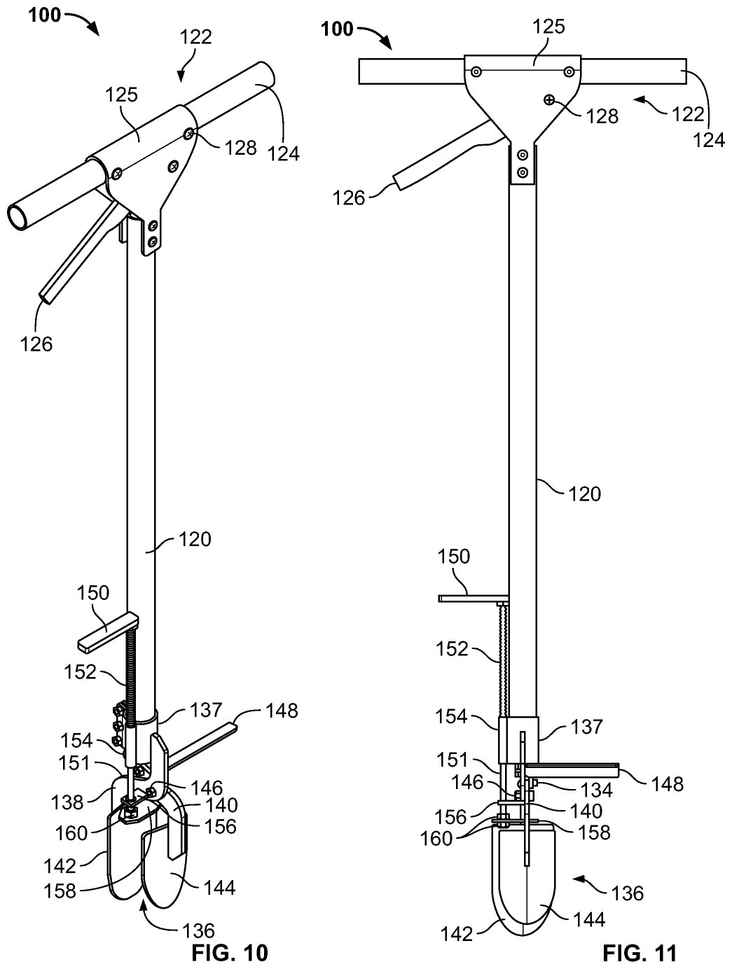

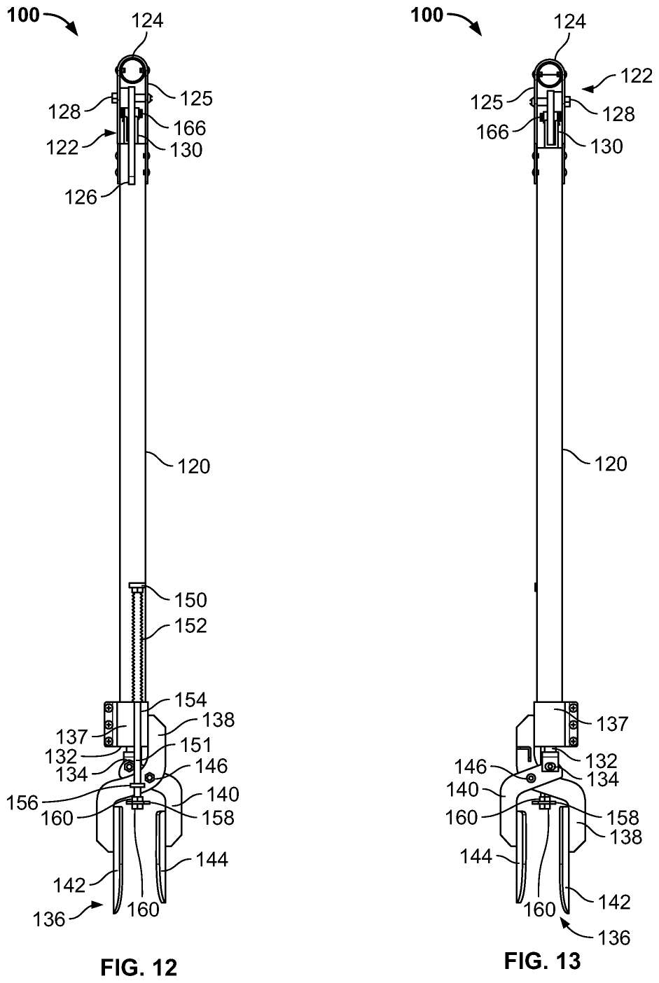

FIGS. 10-13 provide schematic depictions of a weeding device 100 with a cross handle 124. The weeding device 100 may comprise a body 120 in communication with a handle 122 and one or more jaws 136 at opposing ends of the body 120. The handle mechanism 122 may include a handle flange 125 supporting a cross handle 124 and a grip lever 126 in communication with the upper end of the weeding device 100 body 120. The grip lever 126 may be rotatably affixed or otherwise attached to the handle flange 125 at a handle pivot 128 which allows the grip lever 126 to be squeezed or otherwise rotated upwards from a rest position to be closer to the cross handle 124. The grip lever 126 may also be affixed or otherwise attached to a rod 132 via a rotating pivot 166 and an upper connection 130. The arrangement of the handle pivot 128 and rotating pivot 166 is such that when the grip lever 126 is squeezed or rotated upwards towards the cross handle 124, the rod 132, via the upper connection 130 and the rotating pivot 166, will be translated vertically along the central axis of the body 120 of the weeding device 100. The rotating pivot 166 allows for an additional degree of rotational freedom to help prevent binding or misalignment of the rod 132 in translating motion from the handle 122 to the jaws 136 of the weeding device 100.

Still referring to FIGS. 10-13, the weeding device 100 also includes a fixed jaw 138, which may be attached or otherwise affixed directly to the body 120, or may be attached or otherwise affixed to the body 120 through a jaw collar 137, with a fixed blade 142. A moveable jaw 140 with a moveable blade 144 may be rotatably attached to the fixed jaw 138 via a jaw pivot 146. The moveable jaw 140 may be connected to the rod 132 via a lower connection 134 such that when the grip lever 126 is squeezed, the rod 132 translates vertically and raises the lower connection 134, subsequently causing the moveable jaw 140 to rotate about the jaw pivot 146 and reduce the distance between the moveable jaw 140 and the fixed jaw 138 to cause a grasping or closing motion of the jaws 136.

The weeding device 100 may also include an optional ejector 158 located between the fixed jaw 138 and the moveable jaw 140. The ejector 158 may be attached or otherwise affixed to an ejector rod 151 via one or more ejector adjustment bolts 160. The ejector 158 may then be extended or otherwise manipulated by a user through an ejector pedal 150 attached to an upper end of an ejector rod 151. The ejector 158 and ejector rod 151 may be retained on the weeding device 100 by an upper ejector guide 154 and a lower ejector guide 156 and may be held in a retracted position by a spring 152. It should be appreciated that the ejector 158 and ejector rod 151 may be in slidable communication through any connection means or any number of ejector guides as desired or required.

The weeding device 100 may arrange the cross handle 124, grip lever 126, ejector pedal 150, and an optional pedal 148 to be perpendicular to the central axis of the body 120 of the weeding device. In certain embodiments, the cross handle 124, grip lever 126, ejector pedal 150, and pedal 148 may also be radially aligned about the body 120 of the weeding device 100 such that a user may easily have access to the ejector pedal 150 and pedal 148 with the user's hands or feet while the user grasps the cross handle 124, grip handle 126, or both, without having to rotate or otherwise reposition the weeding device 100 during use.

Referring to FIGS. 1-2 and 10-13, the ejector 58, 158 may also provide a jaw-release function. As the ejector 58, 158 is located between the jaws 36, 136 of the weeding device 10, 100, when a user extends the ejector 58, 158 to displace or dislodge a weed or dirt plug, the ejector 58, 158 will separate the jaws 36, 136 and return them to their original, open position. The ejector 58, 158 may also include one or more features to prevent the ejector 58, 158 from extending beyond the jaws 36, 136 and causing interference by catching on the jaws 36, 136 or twisting such that it will not return to its original, retracted position. For example, the ejector rod 50, 151 may include one or more flat sections, or may be made of non-circular material such as, but not limited to, square, oval, triangular, or any other cross-sectional shape as necessary to prevent the rotation of the ejector rod 50, 151 with respect to any guides 54, 56, 154, 156 it passes through. Furthermore, the ejector rod 50, 151 or ejector 58, 158 may include tabs, protrusions, or other shapes that interfere with the guide ears 54, 56 or ejector guides 154, 156 or other features of the weeding device 10, 100 to limit the extension of the ejector 58, 158 so that it may not extend beyond the jaws 36, 136.

In order to remove a weed, a user may take the weeding device 10, 100 and place the jaws 36, 136 around or about the base of the weed or proximate to the item the user wishes to remove. The user may then apply a force to the handle 22, 122 of the weeding device 10, 100, or they may step on or otherwise apply a force to the pedal 48, 148 to cause the blades 42, 44, 142, 144 of the jaws of the weeding device 10, 100 to plunge into or penetrate the ground. The user may then squeeze the handle 22, 122 or grip lever 126 to close the jaws 36, 136 of the weeding device 10, 100 and grasp the weed by the root. Once secured, the user may pull up directly on the weeding device 10, 100 and pull the weed straight out of the ground with little to no ground damage. Once removed, the weed and associated dirt plug may be ejected from the jaws 36, 136 by pushing the ejector rod 50, 151 forward to release the weed and dirt plug. The user may then release the ejector rod 50, 151 and the return spring 52, 152 will retract it into its original position.

The design of the weeding device 10, 100 allows for additional functionality depending on the condition of the ground and the item a user wishes to remove from the ground. For example, the user may squeeze the handle 22, 122 or grip lever 126 of the weeder 10, 100 to close the jaws 36, 136 and use the weeder 10, 100 as a spade or a tool to loosen particularly hard or packed ground around a weed prior to removal. The ground-breaking function of the weeder 10, 100, either with the jaws 36, 136 closed to form a single spade or with the jaws 36, 136 open to allow both blades 42, 44, 142, 144 to penetrate and break up the soil, may be useful when removing a particularly large weed or a weed with a large root ball. For instance, a user may penetrate the ground with the jaws 36, 136 of the weeder 10, 100 multiple times around a large weed to loosen the weed, its root ball, and the surrounding dirt. Once the ground has been broken and the root ball loosened, the user may then penetrate into the ground, the root ball, or both, and use the grasping function of the jaws 36, 136 to remove a weed and its associated root ball even though they may be larger in diameter than the jaws 36, 136 when fully opened. Similarly, a user may insert the jaws 36, 136 of the weeder 10, 100 into the ground at the base of a weed, remove the jaws 36, 136 from the ground, and re-insert them in an offset position. A user may repeat this process multiple times working around the base of the weed to loosen the dirt and remove the weed and its root system.

A user may also adjust the opening of the weeder 10, 100 jaws 36, 136 by squeezing or otherwise rotating the lower handle 26 or grip lever 126 about the handle pivot 28, 128 to set the appropriate opening of the jaws 36, 136 prior to penetrating the ground. For example, the jaws 36, 136 of the weeding device 10, 100 may be partially closed prior to plunging by squeezing the handle 22, 122 or grip lever 126 of the weeder to allow for a smaller opening when removing smaller weeds. This results in less damage to the ground and less excess dirt removal while removing a weed. The user may also twist or lever the weeder 10, 100 side to side to loosen a weed and its roots during removal. The weeder 10, 100 may also be used as a tool to remove dirt plugs from the ground when planting flowers or other small plants.

Still referring to FIGS. 1-2 and 10-13, the motion of the lower handle 26, grip lever 126, rod 32, 132, and jaws 36, 136 is independent of the pressing or penetrating function of the weeder 10, 100, allowing for extra control by the user. For example, a user may apply a very large force to the upper handle 24, cross handle 124, or the pedal 48, 148 of the weeder 10, 100 to penetrate the blades 42, 44, 142, 144 of the jaws 36, 136 into stiff or compacted ground. However, once the penetration of the blades 42, 44, 142, 144 has occurred, the user may finely control the amount of grasping pressure applied by the jaws 36, 136 to the weed, rock, or other object embedded within the ground. This allows a user to separate the penetrating and grasping functions of the weeder 10, 100 to penetrate ground of varying firmness while grasping items firmly or gently depending on the requirements for removing that particular weed or item. For example, a user may apply a large force to the upper handle 24, cross handle 124, or pedal 48, 148 of the weeder 10, 100 to penetrate stiff ground around a small, fragile weed. The user may then gently squeeze the lower handle 26 or grip lever 126 towards the upper handle 24 or cross handle 124 to apply a small amount of grasping pressure to a small, fragile weed to remove the weed and its root system without breakage. Similarly, in the case of a large weed in soft ground, a user may apply a small force to penetrate the blades 42, 44, 142, 144 of the jaws 36, 136 into the soil and then firmly squeeze the lower handle 26 or grip lever 126 towards the upper handle 24 or cross handle 124 to apply a strong grasping pressure to a large weed and secure the full root system for removal. The separation of the penetrating and grasping functions of the weeder 10, 100 allows a user to apply the appropriate penetrating and grasping functions in all circumstances. This greatly enhances user control while reducing the risk of damaging soft ground or breaking weed roots that may lead to regrowth of the weed that was removed.

Referring to FIGS. 1-13, it should be appreciated that any components of the weeding device 10, 100 may be manufactured or formed from a multitude of materials that satisfy the working requirements of the invention. This includes, but is not limited to, plastics, polymers, composites, metals, alloys and any combination thereof. This also includes, but is not limited to, materials molded or otherwise formed in order to have changing properties in any fashion including, but not limited to, along their length or across their section. This change in properties may either be by section or continuous in nature. The materials selected for the weeding device 10, 100 may be selected based on ease of manufacturing, price, material properties such as density, strength, modulus of elasticity, electrical or thermal conductivity, and biological compatibility. Furthermore, in certain embodiments, the weeding device 10, 100 may incorporate materials, coatings, or treatments that make the surface corrosion resistant or to apply surface textures or properties as required.

The applicant contemplates within the context of this invention that it may be produced in any geometrical form with variable length, width, shape, size, or other dimensional variability to match the requirements of specific applications for use.

It should be appreciated that the weeding device 10, 100 may be manufactured in a variety of ways. Specifically, this includes forming, molding, stamping, casting, forging, or otherwise producing components, sub-components, or portions thereof. The device may be produced as an assembly of parts wherein those parts are attached in any manner, including but not limited to fusing, welding, friction fits, threaded connections, snap connections, adhesives, or any other method for connecting one component, sub-component, or any portion thereof to another component, sub-component or portion thereof. The weeding device 10, 100 may also be manufactured so as to combine different functional elements into a single, multi-function component that would take on the function of two otherwise separate components.

It should be appreciated that various sizes, dimensions, contours, rigidity, shapes, flexibility and materials of any of the components or portions of components in the various embodiments discussed throughout may be varied and utilized as desired or required. Similarly, locations and alignments of the various components may vary as desired or required.

It should be appreciated that any of the components or modules referred to with regards to any of the present invention embodiments discussed herein, may be integrally or separately formed with one another. Further, redundant functions or structures of the components or modules may be implemented.

It should be appreciated that the weeding device 10, 100 and related components discussed herein may take on all shapes along the entire continual geometric spectrum of manipulation of x, y and z planes to provide and meet the anatomical and structural demands and operational requirements. Moreover, locations and alignments of the various components may vary as desired or required.

In summary, while the present invention has been described with respect to specific embodiments, many modifications, variations, alterations, substitutions, and equivalents will be apparent to those skilled in the art. The present invention is not to be limited in scope by the specific embodiment described herein. Indeed, various modifications of the present invention, in addition to those described herein, will be apparent to those of skill in the art from the foregoing description and accompanying drawings. Accordingly, the invention is to be considered as limited only by the spirit and scope of the following claims, including all modifications and equivalents.

Still other embodiments will become readily apparent to those skilled in this art from reading the above-recited detailed description and drawings of certain exemplary embodiments. It should be understood that numerous variations, modifications, and additional embodiments are possible, and accordingly, all such variations, modifications, and embodiments are to be regarded as being within the spirit and scope of this application. For example, regardless of the content of any portion (e.g., title, field, background, summary, abstract, drawing figure, etc.) of this application, unless clearly specified to the contrary, there is no requirement for the inclusion in any claim herein or of any application claiming priority hereto of any particular described or illustrated activity or element, any particular sequence of such activities, or any particular interrelationship of such elements. Moreover, any activity can be repeated, any activity can be performed by multiple entities, and/or any element can be duplicated. Further, any activity or element can be excluded, the sequence of activities can vary, and/or the interrelationship of elements can vary. Unless clearly specified to the contrary, there is no requirement for any particular described or illustrated activity or element, any particular sequence or such activities, any particular size, speed, material, dimension or frequency, or any particular interrelationship of such elements. Accordingly, the descriptions and drawings are to be regarded as illustrative in nature, and not as restrictive. Moreover, when any number or range is described herein, unless clearly stated otherwise, that number or range is approximate. When any range is described herein, unless clearly stated otherwise, that range includes all values therein and all sub ranges therein. Any information in any material (e.g., a United States/foreign patent, United States/foreign patent application, book, article, etc.) that has been incorporated by reference herein, is only incorporated by reference to the extent that no conflict exists between such information and the other statements and drawings set forth herein. In the event of such conflict, including a conflict that would render invalid any claim herein or seeking priority hereto, then any such conflicting information in such incorporated by reference material is specifically not incorporated by reference herein.

I claim:

1. A weeding device comprising:
a body having a first end, a second end, and a central axis;
a handle in communication with said first end of said body;
jaws in communication with said second end of said body; and
a rod aligned with said central axis of said body and in communication with said handle and said jaws;
wherein said rod may translate motion from said handle to said jaws to open and close said jaws.

2. The weeding device of claim 1, further comprising a pedal in communication with said second end of said body.

3. The weeding device of claim 1, wherein said handle comprises:
an upper handle in communication with said first end of said body; and
a lower handle in rotatable communication with said upper handle and in communication with said rod through an upper connection;
wherein said lower handle may rotate relative to said upper handle and translate said rod along said central axis of said body.

4. The weeding device of claim 3, further comprising an adjustment mechanism between said upper connection and said rod allowing for adjustment of the effective length of said rod.

5. The weeding device of claim 1, wherein said jaws comprise:
a fixed jaw in communication with said second end of said body; and
a moveable jaw rotatably affixed at a pivot to said fixed jaw and in communication with said rod;
wherein said moveable jaw may rotate with respect to said fixed jaw to open or close said jaws.

6. The weeding device of claim 6, further comprising a fixed blade in communication with said fixed jaw and a moveable blade in communication with said moveable jaw.

7. The weeding device of claim 7, wherein said fixed blade extends further from said body than said moveable blade.

8. The weeding device of claim 5, wherein said moveable jaw is in communication with said rod through a rod end bearing.

9. The weeding device of claim 1, further comprising a sheath enclosing said jaws and in slidable communication with said jaws.

10. The weeding device of claim 9, wherein said sheath is held in an extended position via a spring.

11. The weeding device of claim 1, further comprising a cross handle in communication with said body.

12. The weeding device of claim 1, further comprising an ejector disposed within said jaws of said weeding device, wherein said ejector may translate parallel to said central axis of said body.

13. The weeding device of claim 12, further comprising an ejector rod in communication with said ejector, wherein said ejector rod may translate parallel to said central axis of said body and subsequently translate said ejector within said jaws.

14. The weeding device of claim 13, further comprising a spring in communication with said ejector rod, wherein said spring holds said ejector rod and said ejector in a retracted position.

15. A weeding device comprising:
a body having a first end, a second end, and a central axis;
an upper handle in communication with said first end of said body;
a lower handle rotatably affixed to said upper handle;
a fixed jaw in communication with said second end of said body;
a moveable jaw rotatably affixed to said fixed jaw;
an ejector rod in communication with a spring and an ejector; and
and a rod in communication with said lower handle and said moveable jaw;
wherein said rod translates parallel to said central axis of said body and transfers motion from said lower handle to said moveable jaw, said ejector is disposed between said fixed jaw and said moveable jaw and may translate parallel to said central axis of said body, and said spring retains said ejector rod and said ejector in a retracted position.

16. A weeding device comprising:
a body having a first end, a second end, and a central axis;
a handle in communication with said first end of said body, wherein said handle is perpendicular to said central axis of said body;
a grip lever rotatably affixed to said handle;
a fixed jaw in communication with said second end of said body;
a moveable jaw rotatably affixed to said fixed jaw; and
a rod in communication with said grip lever and said moveable jaw;
wherein said rod may translate parallel to said central axis of said body and transfer motion from said grip lever to said moveable jaw to rotate said moveable jaw about a jaw pivot on said fixed jaw.

17. The weeding device of claim 16, wherein said handle is a cross handle extending from both sides of said first end of said body.

18. The weeding device of claim 17, further comprising a pedal, wherein said pedal is in communication with said body and positioned perpendicular to said central axis of said body and radially aligned with said cross handle.

19. The weeding device of claim 18, further comprising:
an ejector disposed between said fixed jaw and said moveable jaw;
an ejector rod in communication with said ejector;
a spring in communication with said ejector rod; and
an ejector pedal in communication with said ejector rod;
wherein said spring holds said ejector in a retracted position and said ejector pedal is disposed on an opposite end of said ejector rod from said ejector.

20. The weeding device of claim 19, wherein said ejector pedal is disposed perpendicular to said central axis of said body and radially aligned with said cross handle.
